(19) United States
(12) Patent Application Publication
(10) Pub. No.: US 2021/0084012 A1
(43) Pub. Date: Mar. 18, 2021

(54) METHODS AND SYSTEMS OF AN AUTOMATIC CENTRALIZED FIREWALL FOR INDUSTRIAL IOT WAN FABRIC

(71) Applicants: RONALD DAVID VICTOR, los gatos, CA (US); DHAWAL TYAGI, saratoga, CA (US); SRIVATSAN RAJAGOPAL, cupertino, CA (US); DHRUVA NARASIMHAN, chennai (IN)

(72) Inventors: RONALD DAVID VICTOR, los gatos, CA (US); DHAWAL TYAGI, saratoga, CA (US); SRIVATSAN RAJAGOPAL, cupertino, CA (US); DHRUVA NARASIMHAN, chennai (IN)

(21) Appl. No.: 16/876,113

(22) Filed: May 17, 2020

Related U.S. Application Data
(63) Continuation-in-part of application No. 16/855,223, filed on Apr. 22, 2020.
(60) Provisional application No. 62/837,038, filed on Apr. 22, 2019.

(51) Int. Cl. H04L 29/06; G16Y 30/10

(52) U.S. Cl. CPC H04L 63/0263; H04L 63/0209; H04L 2463/141; H04L 63/101; G16Y 30/10; H04L 63/1458

(57) ABSTRACT

In one aspect, a computerized method for implementing an automatic centralized firewall for industrial Internet of Things-based (IIOT) wide area network (WAN) fabric includes the step of providing an automatic centralized firewall in an IIOT-based WAN fabric. The method includes the step of strictly operating the automatic centralized firewall in a white-listed manner. The method includes the step of automatically discovering a set of subnet end points and a set of network address ranges for each network in the IIOT-based WAN fabric. The method includes the step of providing a set of flow rues at both ends of each machine network in the WAN fabric.

### CROSS-REFERENCE TO RELATED APPLICATIONS

This application claims priority to U.S. application Ser. No. No. 16/855,223, titled and METHODS AND SYSTEMS OF A MACHINE ACCESS FIREWALL filed on 22 Apr. 2020. U.S. application Ser. No. 16/855,223 claims priority to U.S. Provisional Application No. 62/837,038, titled and METHODS AND SYSTEMS OF A HYBRID-CLOUD OT NETWORK filed on 22 Apr. 2019. This provisional application is incorporated by reference in its entirety.

### BACKGROUND

### 1. Field

This application relates generally to computer networking, and more specifically to a system, article of manufacture and method for implementing an automatic centralized firewall for industrial IOT WAN fabric.

### 2. Related Art

Machines are used in everyday manufacturing, building automation and industrial automation tasks. For security reasons, access to these machines may be restricted to local physical access (e.g. air-gapped). There is a need to reduce costs of machine operations. A model of choice is to do so remotely either via Internet or a Private WAN Network. Security by isolation may be prohibitively expensive for this class of applications. Traditional IT-based remote connectivity technologies such as VPN and agent-based solutions have been designed for office and data center and site-to-site environments and does no to operationally scale to be deployed and managed in a distributed non-IT enabled environments. The control plane overhead on maintaining the Privacy and Authentication aspects of the security is so expensive that largely that is left unmanaged—leading to loss of data plane security due to inadequate management.

Moreover, machines often live in a multi-tenanted environment, where the network is owned by one entity and the machine is owned by a second, the human operator may belong to a 3^{rd} party service vendor and the application to yet another fourth Analytics organization. It can be challenging to operate a VPN based remote access in such a multi-tenanted environment. This may be because it is difficult to implement best practices around mutual authentication, privacy controls, password/key management across third parties.

It is further noted that a large percentage of Industrial IoT, machine to machine and machine to application communication flows are very predictable. This can be the case in distributed building networks; energy production networks (e.g. both large scale production and distributed micro-grid productions, etc.), as well as any kind of distributed critical infrastructure network. In these cases, a deviance from the deterministic flows in itself can be an indication of presence of anomalies in the system. Current firewalling methods are extremely difficult to implement in a distributed manner, and the complexity leads to gaps and hence in itself a vulnerability. Moreover, the cost to implement is also be high.

### BRIEF SUMMARY OF THE INVENTION

In one aspect, a computerized method for implementing an automatic centralized firewall for industrial Internet of Things-based (IIOT) wide area network (WAN) fabric includes the step of providing an automatic centralized firewall in an IIOT-based WAN fabric. The method includes the step of strictly operating the automatic centralized firewall in a white-listed manner. The method includes the step of automatically discovering a set of subnet end points and a set of network address ranges for each network in the IIOT-based WAN fabric. The method includes the step of providing a set of flow rules at both ends of each machine network in the WAN fabric.

### BRIEF DESCRIPTION OF THE DRAWINGS

FIG. 1 illustrates an example process for implementing a hybrid-cloud OT network, according to some embodiments.

FIG. 2 illustrates an example process for implementing OT-Proxies, according to some example embodiments.

FIG. 3 illustrates an example process for implementing a WAN data diode with the same uni-directional semantics, according to some embodiments.

FIG. 4 illustrates an example process for implementing an automated centralized firma For industrial IOT wan fabric, according to some embodiments.

FIG. 5 illustrates an example process for implementing application migration across the wan, according to some embodiments.

FIG. 6 illustrates an example process for zero touch plumbing of independent private networks for scalable hub and spoke IIOT deployments.

The Figures described above are a representative set and are not an exhaustive with respect to embodying the invention.

### DESCRIPTION

Disclosed are a system, method, and article of manufacture of an automatic centralized firewall for industrial IOT WAN fabric, the following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Destination network address translation (DNAT) is a technique for transparently changing the destination IP address of an end route packet and performing the inverse function for any replies. Any router situated between two endpoints can perform this transformation of the packet.

Distributed denial-of-service (DDoS) can be a large-scale DoS attack where the perpetrator uses more than one unique IP address or machines, often from thousands of hosts infected with malware.

Edge device is a device which provides an entry point into differently managed enterprise or service provider core networks, such as, inter alia: such as an enterprise IT network or Service Provider Core network. Examples include routers, routing switches, integrated access devices (IADs), multiplexers, and a variety of metropolitan area network (MAN) and wide area network (WAN) access devices. Edge devices also provide connections into carrier and service provider networks or connections between OT and Enterprise IT networks.

Industrial Internet of Things (IIOT) refers to interconnected sensors, instruments, and other devices networked together with computers' industrial applications, including, but not limited to, manufacturing and energy management. This connectivity enables data collection, exchange and analysis, potentially facilitating is in productivity and efficiency as well as other economic benefits.

Internet of things (IoT) extends Internet connectivity into physical devices and various objects. Embedded with electronics, Internet connectivity, and other forms of hardware (e.g. sensors), these devices can communicate and interact with others over the Internet, and they can be remotely monitored and controlled.

Key management refers to management of cryptographic keys in a cryptosystem. This can include dealing with the generation, exchange, storage, use, crypto-shredding (e.g. destruction) and replacement of keys. It can include cryptographic protocol design, key servers, user procedures, and/or other relevant protocols.

Operational Technology (OT) includes the hardware and software dedicated to detecting or causing changes in physical processes through direct monitoring and/or control of physical devices.

Operational Technology (OT) Proxies are boundary devices which implement and enforces the necessary protocol translation and security semantics needed for interconnected OT network elements (devices and applications) to talk to each other, often through and over a different network such as an Enterprise IT network or third-party carrier and service provider networks.

Proxy authentication can serve as access-control. Proxy authentication can provide a mechanism that blocks requests for content until a valid access-permission credentials to the proxy is provided.

Remote procedure call (RPC) is when a computer program causes a procedure (e.g. subroutine) to execute in a different address space (e.g. on another computer on a shared network), which is coded as if it were a normal (e.g. local) procedure call, without the programmer explicitly coding the details for the remote interaction.

Stream is a sequence of data elements made available over time.

Tunneling protocol can be a communications protocol that allows for the movement of data from one network to another. It can involve allowing a private network communication to be sent across a public network.

User Datagram Protocol (UDP) is one of the core members of the Internet protocol suite used by computer applications to send messages (e.g. datagrams) to other hosts on an Internet Protocol OP) network. Prior communications are not required in order to set up communication channels or data paths.

### EXAMPLE METHODS

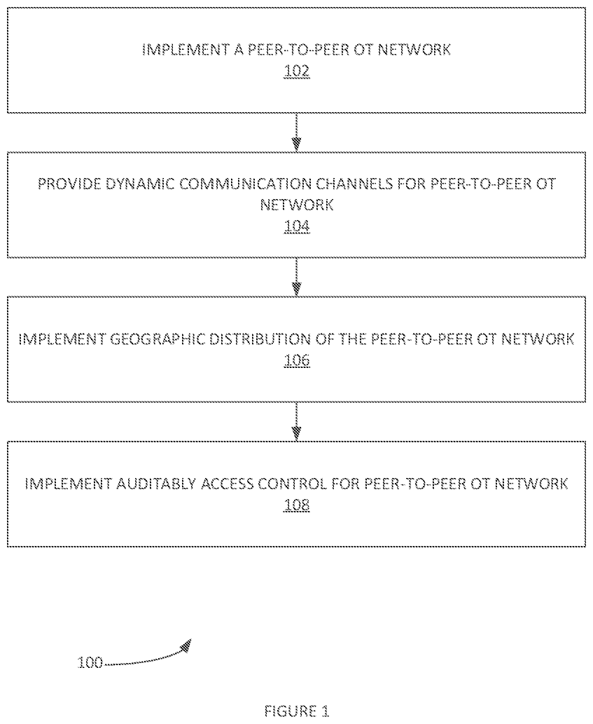

FIG. 1 illustrates an example process 100 for implementing a hybrid-cloud OT network, according to some embodiments. In step 102, process 100 provides a hybrid-cloud OT network that can scale to n-number segmented communication channels (e.g. hundreds of thousands of segmented communication channels, etc.). In step 104, process 100 can provide dynamic communication channels for hybrid-cloud OT network. These communication channels are not necessarily always-on. In step 106, process 100 can implement geographic distribution of the hybrid-cloud OT network. For example, the hybrid-cloud OT network can be distributed to the geographic locations of machines, applications, and humans. In step 108, process 100 can implement auditable access control for hybrid-cloud OT network. This can be done for security and compliance. The hybrid-cloud OT network minimal operational overhead. Process 100 can connect OT networks in one location to those in other locations (e.g. a factory floor, budding, public cloud, private data center, etc.

### Machine Access Firewall Comprehensive Access Control for Mission Critical Industrial Machines by Humans and Applications

It is noted that OT-Proxies can be implemented. OT-Proxies provide a scalable solution and utilize a converged firewall. OT-Proxies can be used to connect people, applications and machines in a secure, controlled and auditable manner in a distributed, micro-network, multi-tenanted environment. OT-Proxies can be implemented in brownfield networks and/or device environments with no additional forklift upgrade of the already functional end devices and applications. In addition, OT-Proxies can increase operational efficiency of a system where the privacy and authentication aspects of security for the system are covered automatically.

Example of OT technologies include, inter alia: converting one type of network (e.g. a serial network to ethernet) to another, converting Modbus based messages to time series based JSON messages, enforcing that only specific protocols are allowed and rest are blocked etc.

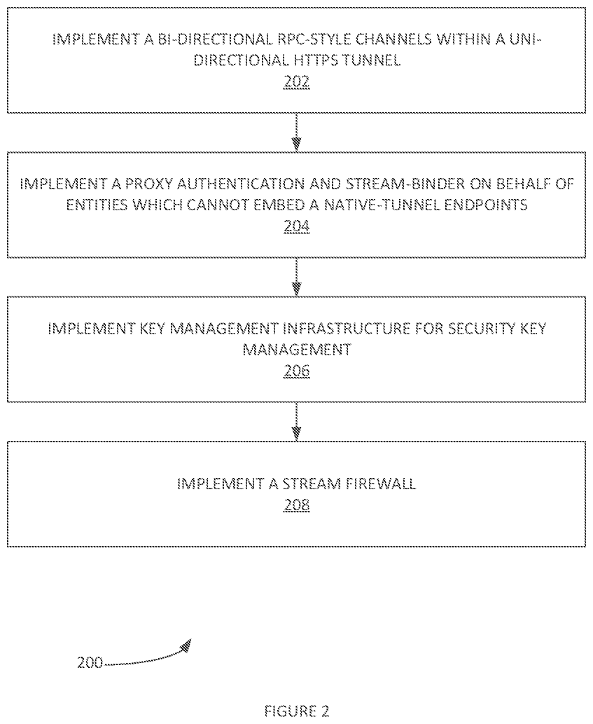

FIG. 2 illustrates an example process 200 for implementing machine identity firewall, according to some example embodiments. In step 202, process 200 can implement a bi-directional RPC-style channels within a uni-directional HTTPS tunnel. This model can be used for both local and remote connectivity. Tunnel end points are at each application and machine which wish to connect in a peer-to-peer format. Peer-to-peer communication channels lends itself well to both segmented and scalable implementation.

In step 204, process 200 can implement a proxy authentication and stream-binder on behalf of entities which cannot embed a native-tunnel endpoints. The proxy end points convert one authentication format to another and bridges one communication path to the next. This can be used for an implementation in brownfield environments (e.g. an asset base of millions of machines, legacy applications, etc.).

In step 206, process 200 can implement key management infrastructure for security key management. This can eliminate IT department's overhead associated with it.

In step 208, process 200 can implement a stream firewall, The stream firewall provides access control on a segmented per-stream basis (e.g. a human access stream, an application stream for each end device, etc.).

### Software Data Diode—TCP Proxy With UDP Across the WAN—Extending Conceptual Data Diodes Across the Internet

It is noted that data diodes are hardware devices used in an industrial environment to restrict and guarantee flow of information one way. For example, data diodes can be used for data extraction from critical infrastructure devices while eliminating the risk of malware traversing in the opposite direction into those devices. Applications can be hosted in a cloud-computing platform and similar semantics may not be available across a WAN/Internet, when devices connect to the remote applications.

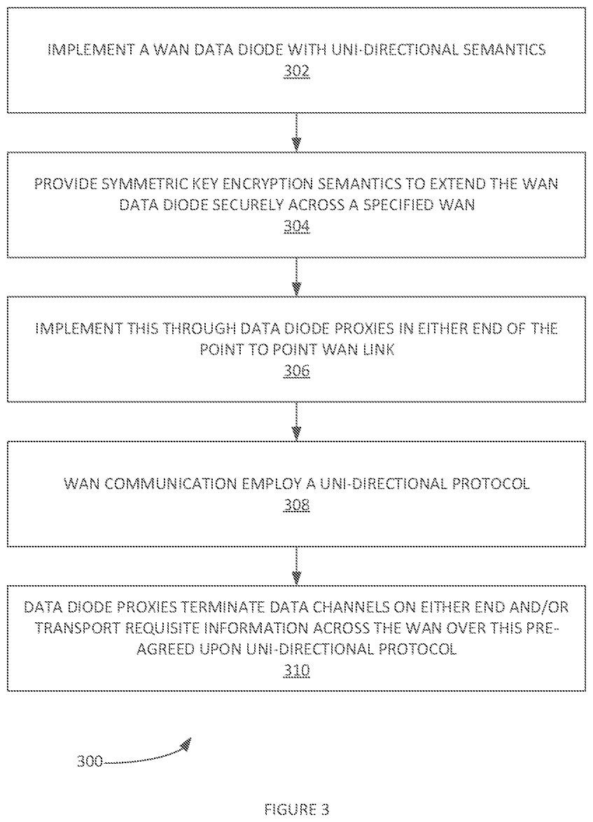

FIG. 3 illustrates an example process 300 for implementing a WAN data diode with the same unidirectional semantics, according to some embodiments. In step 302, process 300 can implement a WAN data diode with uni-directional semantics. In step 304, process 300 can provide symmetric key encryption semantics to extend the WAN data diode securely across a specified WAN.

In step 306, process BOB can implement this through data diode proxies in either end of the point to point WAN link. The proxies at both ends communicate with each other across the WAN via an encapsulating Uni-directional protocol. Bi-directional protocols such as TCP is inherently is bi-directional (e.g. with Acks flowing the other direction). In order to eliminate any back channel, the WAN communication employ a uni-directional protocol in step 308. An example unidirectional protocol can include UDP. Process 300 can pack/unpack the data formats into the uni-directional protocol encapsulatlon.

In step 310, the data diode proxies terminate data channels on either end and/or transport requisite information across the WAN over this pre-agreed upon uni-directional protocol. This change in carrier can be used to eliminate direct communication between the two ends (e.g. a device end and application end) and thereby enforcing both a diode semantic and a secure proxy semantic (e.g. including additional encryption).

### Automatic Centralized Firewall for Industrial IOT WAN Fabric

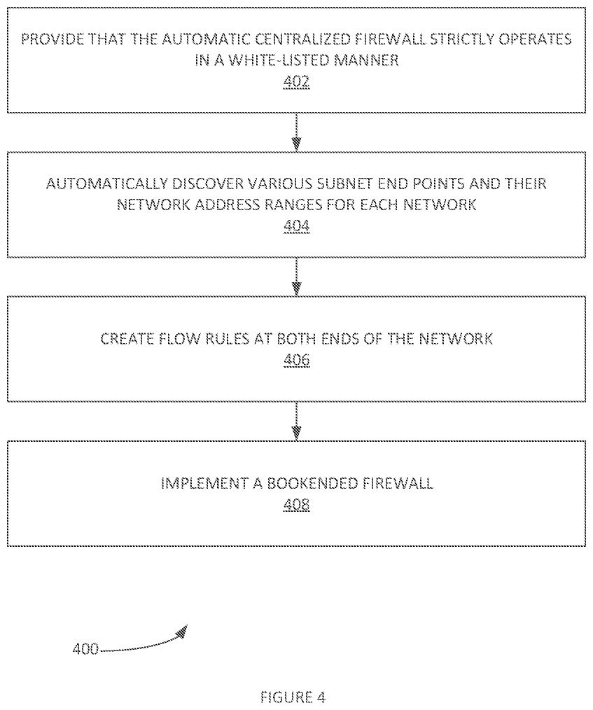

FIG. 4 illustrates an example process 400 for implementing an automatic centralized firewall for industrial IOT WAN fabric, according to some embodiments. A fabric can be computer network topology where many devices connect with each other. Process 400 can provide a centralized cloud-managed auto-learning micro-network firewalls for large scale WAN distributed machine and application networks. In step 402, process 400 provides that the automatic centralized firewall strictly operates in a white-listed manner. In step 404, process 400 automatically discovers various subnet end points and their network address ranges for each network. In step 406, process 400 creates flow rules at both ends of the network. This can be from the machine network end and from the remote access networks. In step 408, process 400 implements a bookended firewall. Process 400 can eliminate DDOS of the WAN fabric while providing appropriate access control to machines and applications. Process 400 can have a low rollout and low deployment costs. Process 400 can be implemented with COTS hardware. Commercial off-the-shelf (COTS) products can be packaged solutions which are then adapted to satisfy the needs of the purchasing organization, rather than the commissioning of custom-made, or bespoke, solutions. Process 400 can centralize control and distributes enforcement. Process 400 can provide both firewall and DDOS protection at the same time.

### Application Migration Across the WAN

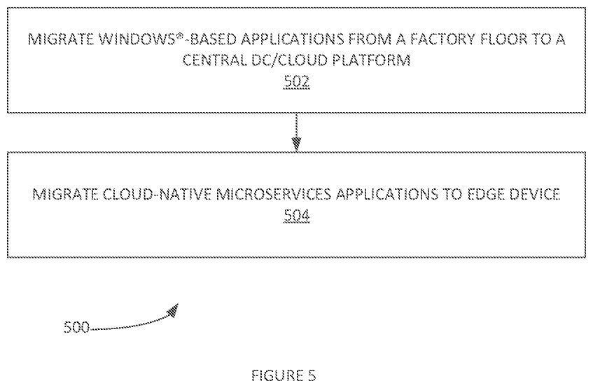

FIG. 5 illustrates an example process 500 for implementing application migration across the wan, according to some embodiments. Process 500 provides a mechanism for secure application migration. Process 500 can leverage the same channels used to migrate data securely. Process 500 can automatically reuse cloud-based applications at an edge device and vice versa. Process 500 can implement application migration in an industrial context. In step 502, process 500 can migrate Windows®-based applications from a factory floor to a central DC/Cloud platform. In step 504, process 500 can migrate cloud-native microservices applications to edge device. Process 500 does not mandate changes/rewrite of the applications. Process 500 does not implement invasive changes to network planning or configuration. Process 500 can provide OT-Proxies integrated with edge compute system to facilitate migration of applications across the WAN.

It is noted that application migration across the WAN (e.g. from factory to Cloud and vice versa) can be enforced without changes to management and ownership of the application. Process 500 can facilitate the management and operations of such applications is the separation of the infrastructure layer from the Application runtime. Process 500 provides a multi-tenant management such that the data scientist can own and manage the application without having to take on additional ownership and management overhead of the infrastructure in the factory floor (e.g. can be left to the network and security teams, etc.).

### Additional Methods and Systems

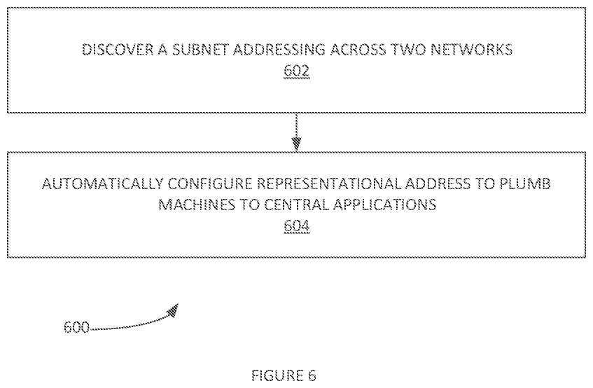

FIG. 6 illustrates an example process 600 for zero touch plumbing of independent private networks for scalable hub and spoke IIOT deployments (e.g. discovery and mutual Static Network Address Translation (SNAT)/DNAT). In step 602, process 600 can discover a subnet addressing across two networks. In step 604, process 600 can automatically configure representational address to plumb machines to central applications. Process 600 provides a scalable deployment model for IPv4 based large scale building networks. Process 600 can represent remote networks differently. Process 600 can prevent/reduce cost of forklift upgrade to IPv6 for scale.

Late binding labels for rapid deployment at scale can be implemented. This can be done by decoupling actual resources from configuration schemas to allow for late bind deployments.

Per machine independent keys for data plane and management plane can be implemented. Edge strategy can be implemented to solve this problem in locations where physical device security is solved as opposed to per device keys. Machine management can be decoupled from data acquisition. There can be complete separation of the operation plane and data plane.

Risk mitigation and incremental migration of automation services to a cloud-platform can be provided. Single-click network sharing across disparate organizations/third parties and machine interfaces can be extended across untrusted networks. OT-Proxies for IIOT can be provided as a secure model for onboarding air-gapped brownfield assets to the Internet/WAN.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means For achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing an automatic centralized firewall for industrial Internet of Things-based (IIOT) wide area network (WAN) fabric comprising:
providing an automatic centralized firewall in an IIOT-based WAN fabric;
strictly operating the automatic centralized firewall in a white-listed manner;
automatically discovering a set of subnet end points and a set of network address ranges for each network in the IIOT-based WAN fabric; and
providing a set of flow rules at both ends of each machine network in the WAN fabric.

2. The computerized method of claim 1 further comprising:
providing a centralized cloud-managed auto-learning micro-network firewall for a large-scale WAN distributed machine and an application network.

3. The computerized method of claim 1, wherein the step of providing the set of flow rules at both ends of each network is implemented from a machine network end and from a remote access network.

4. The computerized method of claim 1, further comprising:
eliminating a DDOS attack on the WAN fabric is eliminated while providing appropriate access control to a set of machines of the WAN fabric.

5. The computerized method of claim 1, further comprising:
simultaneously providing both a firewall-based protection and a DDOS protection to the WAN fabric.

6. The computerized method of claim 1, further comprising:
implementing a bookended firewall in the automatic centralized firewall.

7. A computerized system useful for an automatic centralized firewall for industrial Internet of Things-based (IIOT) wide area network (WAN) fabric processing comprising:
a processor;
a memory containing instructions when executed on the processor, causes the processor to perform operations that:
provide an automatic centralized firewall in an IIOT-based WAN fabric;
strictly operate the automatic centralized firewall in a white-listed manner;
automatically discover a set of subnet end points and a set of network address ranges for each network in the IIOT-based WAN fabric; and
provide a set of flow rules at both ends of each machine network in the WAN fabric.

8. The computerized system of claim 7, wherein a centralized cloud-managed auto-learning micro-network firewall is provided for a large-scale WAN distributed machine and an application network.

9. The computerized system of claim 7 wherein the step of providing the set of flow rules at both ends of each network is implemented from a machine network end and from remote access network.

10. The computerized system of claim 7, wherein a DDOS attack on the WAN fabrics eliminated while providing appropriate access control to a set of machines of the WAN fabric.

11. The computerized system of claim 7, wherein a bookended firewall is implemented in the automatic centralized firewall.
